(19) United States
(12) Patent Application Publication
(10) Pub. No.: US 2018/0370707 A1
(43) Pub. Date: Dec. 27, 2018

(54) Smart Packaging Device

(71) Applicant: Resolve Digital Health Inc., Toronto (CA)

(72) Inventor: Robert ADELSON, Vaughn (CA)

(73) Assignee: Resolve Digital Health Inc., Toronto (CA)

(21) Appl. No.: 16/018,579

(22) Filed: Jun. 26, 2018

Related U.S. Application Data
(60) Provisional application No. 62/525,488, filed on Jun. 27, 2017.

(51) Int. Cl. B65D 79/02; B65D 25/20; B65D 5/42; G01K 7/01; G01K 1/02

(52) U.S. Cl. CPC B65D 79/02; B65D 25/205; B65D 5/4216; G01K 7/01; A61J 1/00; G01K 1/024; B65D 2203/06; B65D 2203/12; B65D 2203/10; G01K 1/026

(57) ABSTRACT

The disclosure generally relates to the field of packaging. In particular, the present disclosure relates to a smart packaging device. An aspect of the present disclosure relates to a method of detecting an event of a content stored in a smart packing device being expired. Another aspect of the present disclosure relates to a method of detecting an event of a content stored in a smart packing device being unfit for ingestion. The packaging device and the methods disclosed herein can find advantageous utility for packaging of pharmaceutical, nutraceutical or cosmetic contents.

### TECHNICAL FIELD

The disclosure generally relates to the field of packaging. In particular, the present disclosure relates to a smart packaging device. An aspect of the present disclosure relates to a method of detecting an event of a content stored in a smart packing device being expired. Another aspect of the present disclosure relates to a method of detecting an event of a content stored in a smart packing device being unfit for ingestion. The packaging device and the methods disclosed herein can find advantageous utility for packaging of pharmaceutical, nutraceutical or cosmetic contents.

### BACKGROUND

Background description includes information that may be useful in understanding the present invention. It is not an admission that any of the information provided herein is prior art or relevant to the presently claimed invention, or that any publication specifically or implicitly referenced is prior art.

Packaging is responsible for providing life-saving drugs, medical devices, medical treatments, and new products like medical nutritionals (nutraceuticals) in every imaginable dosage form to deliver every type of supplement, poultice, liquid, solid, powder, suspension, or drop to people all over the world.

With its exposure to increasing raw material prices and customer purchasing power, continuous operational performance improvement is vital in the packaging industry. The quality of packaged goods can vary considerably during shelf-life and requires monitoring. Also, package-tampering events, illegal opening as well as other parameters such as, for example, temperature, pressure, humidity or chemical composition change endured by the packaged goods during shipment and storage, should be monitored.

Innovative packaging systems with enhanced functions are constantly sought in this regard. So-called “intelligent or smart” packaging can be thought of as packaging techniques capable of carrying out intelligent functions (e.g., detecting, sensing, recording, tracing, communicating, and applying scientific logic) to facilitate decision making, extending shelf life, enhancing safety, improving quality, providing information, and warning about possible problems.

Currently used package monitoring approaches that have been implemented to monitor package-tempering events and the like have successfully ensured the integrity of packages during shipment utilizing different types of sealing, so that a tamper event can be visually detected at the time of arrival. Intelligent packaging systems may include internal or external sensors for monitoring external conditions (e.g., temperature, humidity, pressure) or indicator compounds (e.g., volatiles) associated with the packaged goods that can indicate a quality status. Passive wireless monitoring of such packaged goods during transportation and storage in a logistic chain is highly desirable to optimise logistics operations and stock control within the product life cycle and the currently available packaging systems and methods, at least partly, serve to fulfil this aim.

The traditional production methods used in pharmaceutical and allied filed(s) are in the form of manual work to complete assembly, packaging and process components. These traditional manufacturing methods are very cumbersome, fatiguing, time-consuming and error-prone due to significant human intervention. Such methods many a times do not meet the cGMP guidelines and standardization requirements laid down for the production of pharmaceuticals. The repercussions of human intervention may result in product assembly error, low-quality end-product and reduced product yield amongst others.

The current packaging monitoring approaches fail to address the issue of automating the entire production chain of pharmaceutical and allied product(s), which can further coordinate with the mechanized logistic chain to ensure quality of the product all the time and expedite the overall process of packaging with enhanced accuracy and safety. Automation during production can significantly lessen human intervention, ultimately preventing errors such as over-filling of contents in the medical containers, maintaining quality of the end-product, accurate and consistent measurement of key parameters such as tolerance of filling, rate of production, method of sealing, degeneration of adhesives and the like. In general, the currently known solutions address specific parts of the overall problem but have thus far failed to make a significant impact on product quality and safety.

Expiration date of a medication is often determined by the manufacturer using statistical methodology that takes into account predicted environmental conditions to which the drug will be exposed. Once the expiration date is determined, the same is mentioned/specified on the package. However, in several instances it has been observed that the packaging device is tampered so as to alter the expiration date. In such cases, it becomes difficult for the consumer/patient to assess if the content stored in the packaging device is safe for ingestion.

There is therefore a need for a smart packaging device and methods of operating the device that can provide accurate information of the key performance indicators during and after packaging while reducing the human intervention. Need was also felt for a process for packaging of pharmaceutical, nutraceutical or cosmetic contents into a smart packaging devices including a unique identifier.

### SUMMARY OF INVENTION

The disclosure generally relates to the field of packaging. In particular, the present disclosure relates to a smart packaging device. An aspect of the present disclosure relates to a method of detecting an event of a content stored in a smart packing device being expired. Another aspect of the present disclosure relates to a method of detecting an event of a content stored in a smart packing device being unfit for ingestion. Still further aspect of the present disclosure relates to a process for packaging of pharmaceutical, nutraceutical or cosmetic contents into a smart packaging devices including a unique identifier. The packaging device and the methods disclosed herein can find advantageous utility for packaging of pharmaceutical, nutraceutical or cosmetic contents.

An aspect of the present disclosure provides a smart packaging device to store a content therein, the device comprising: a memory having stored therein, a shelf life of the content stored in said device; a counter configured to determine a time lapsed since manufacture of said device; and a controller, configured to detect an event of the content stored in said device being expired, wherein said detection is based on determination of remaining life of the content stored in the device.

In an embodiment, the determination of the remaining life is based on subtraction of the lapsed time since manufacture of said device from the shelf-life of the content stored in said device. In an embodiment, the device further comprises a sensor, configured to detect, at a pre-determined time period, at least one storage condition the content stored in said device is exposed to. In an embodiment, the at least one storage condition is selected from any or a combination of temperature, humidity and pressure. In an embodiment, the memory is further configured to store the detected at least one storage condition. In an embodiment, the controller is configured to determine, based on said detected at least one storage condition, an event of the content of the device being unfit for ingestion. In an embodiment, the device further comprises an indicator, configured to provide any or a combination of a visual indication and an audio indication upon the detection of any or a combination of the event of the content stored in the device being expired and the event of the content of the device being unfit for ingestion. In an embodiment, the indicator comprises a display configured to provide the visual indication upon the detection of the event. In an embodiment, the indicator comprises a buzzer configured to provide the audio indication upon the detection of the event. In an embodiment, the device further comprises a unique identifier associated therewith. In an embodiment, the memory is configured to store a unique identifier associated with said device.

Another aspect of the present disclosure relates to a method of detecting an event of a content stored in a smart packing device being expired, the method comprising the steps of: storing, in a memory associated with said device, a shelf life of the content stored in said device; determining, by a counter, a time lapsed since manufacture of said device; and detecting, by a controller, the event of the content stored in said device being expired, wherein said detection is based on determination of remaining life of the content stored in the device. In an embodiment, the determination of the remaining life is based on subtraction of the lapsed time since manufacture of said device from the shelf-life of the content stored in said device. In an embodiment, the method further comprises the step of indicating, by an indicator, the detection of the event of the content stored in said device being expired.

Still further aspect of the present disclosure relates to a method of detecting an event of a content stored in a smart packing device being unfit for ingestion, the method comprising the steps of: detecting at a pre-determined time period, by a sensor, at least one storage condition the content stored in said device is exposed to; storing, in a memory, the detected at least one storage condition; and determining, by a controller, the event of the content of the device being unfit for ingestion, wherein said determination is based on the detected at least one storage condition. In an embodiment, the at least one storage condition is selected from any or a combination of temperature, humidity and pressure. In an embodiment, the method further comprises the step of indicating, by an indicator, the detection of the event of the content stored in said device being expired.

### BRIEF DESCRIPTION OF DRAWINGS

FIG. 1 illustrates an exemplary schematic depicting components of the packaging device realized in accordance with an embodiment of the present disclosure.

FIG. 2 illustrates an exemplary flow diagram depicting various steps involved in a method of detecting an event of a content stored in a smart packing device being expired.

FIG. 3 illustrates an exemplary flow diagram depicting various steps involved in a method of detecting an event of a content stored in a smart packing device being unfit for ingestion.

FIG. 4 enumerates different steps of a process for packaging of pharmaceutical, nutraceutical or cosmetic contents into a smart packaging device, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description.

Various terms as used herein are shown below. To the extent a term used in a claim is not defined below, it should be given the broadest definition persons in the pertinent art have given that term as reflected in printed publications and issued patents at the time of filing.

The term “packaging device” or “smart packaging device” or “device” as used herein denotes the reservoir or supply container or packaging that may be used for packing or storing the content for supply thereof to the user, including blisters, containers, strips, bottles, vials, canisters, pods and the likes, as known to or appreciated by a person skilled in the art.

The disclosure generally relates to the field of packaging. In particular, the present disclosure relates to a smart packaging device. An aspect of the present disclosure relates to a method of detecting an event of a content stored in a smart packing device being expired. Another aspect of the present disclosure relates to a method of detecting an event of a content stored in a smart packing device being unfit for ingestion. Still further aspect of the present disclosure relates to a process for packaging of pharmaceutical, nutraceutical or cosmetic contents into a smart packaging devices including a unique identifier. The packaging device and the methods disclosed herein can find advantageous utility for packaging of pharmaceutical, nutraceutical or cosmetic contents.

An aspect of the present disclosure provides a smart packaging device to store a content therein, the device comprising: a memory having stored therein, a shelf life of the content stored in said device; a counter configured to determine a time lapsed since manufacture of said device; and a controller, configured to detect an event of the content stored in said device being expired, wherein said detection is based on determination of remaining life of the content stored in the device. In an embodiment, the determination of the remaining life is based on subtraction of the lapsed time since manufacture of said device from the shelf-life of the content stored in said device.

In an embodiment, the shelf life of the content stored in the smart packaging device (alternatively and synonymously referred to herein as “device” or “packaging device”) is determined and fed/stored by the manufacturer in the memory associated with said device. The expiration date of the content may be determined by the manufacturer using statistical methodology that takes into account predicted environmental conditions to which the content will be exposed. The shelf life, as stored in the memory, may be in form of number of days, number of months, number of years or simply in form of a future date, by which the content is estimated to be safe for consumption/ingestion. In an embodiment, the shelf life is also printed on label of the device.

In an embodiment, the counter associated with the device is any of a real time clock circuit or a mechanical counter. The real time clock may be a programmable real time clock, preferably, a programmable integrated circuit real time clock capable of maintaining the absolute time and date. Many real time clocks are commercially available that may be suitable for use with the device of the present disclosure, including products from Dallas Semiconductor Corp., Maxim Integrated Products, Inc., Epson America, Inc., but not limited thereto. A person skilled in the pertinent art would appreciate that although several embodiments of the present disclosure describes the real time clock as a separate component from controller, the clock/clock circuit may be integrated into the controller itself such that the controller can perform a dual function as to determination of a time lapsed since manufacture of the device and detection of an event of the content stored in the device being expired. In an embodiment, the controller is configured to detect the event based on determination of remaining life of the content stored in the device. In an embodiment, the controller determines the remaining life based on subtraction of the lapsed time since manufacture of said device from the shelf-life of the content stored in said device. The controller may fetch the data pertaining to shelf life of the content stored in the memory and may fetch the data pertaining to the time lapsed since manufacture of the device and then determines the remaining life by subtraction of the lapsed time since manufacture of said device from the shelf-life of the content.

In an embodiment, the device further comprises a sensor, configured to detect, at a pre-determined time period, at least one storage condition the content stored in said device is exposed to. In an embodiment, the sensor periodically detects at least one storage condition the content stored in said device is exposed to. Alternatively, the sensor may continuously detect and/or monitor at least one storage condition the content stored in said device is exposed to. In an embodiment, the at least one storage condition is selected from any or a combination of temperature, humidity and pressure.

In an embodiment, the sensor is temperature sensor associated with the device to detect the temperate condition of the device. In an embodiment, the temperature sensor is configured to detect both the ambient temperature (i.e. temperature at which the device is stored/exposed) and the temperature to which the contents of the device is exposed to (i.e. actual temperature of the content stored in the packaging device). Many temperature sensors are commercially available that may be suitable for use with the device of the present disclosure including integrated circuit temperature sensors such as thermisters and resistors, thin film metals, metal oxide semiconductor temperature sensors, CMOS or MOS transistors, bipolar transistors, circuits defining a Wheatstone bridge, but not limited thereto.

In an embodiment, the sensor is pressure sensor associated with the device to detect the pressure inside of the device. Several contents (such as liquid substances/medicaments) tend to built-up pressure on account of release of volatile contents therefrom in response to degradation of such content or simply due to severe temperate conditions that may increase the chances of degradation of the contents or increase the rate at which the content degrades. Accordingly, measuring the pressure inside the packaging device may be helpful in determining/estimating the remaining life of the contents stored in the device. In an embodiment, the pressure sensor is configured to detect both the ambient pressure (i.e. pressure at which the device is stored/exposed) and the pressure to which the contents of the device is exposed to (i.e. actual pressure inside the packaging device). Many pressure sensors are commercially available that may be suitable for use with the device of the present disclosure.

In an embodiment, the sensor is a humidity sensor associated with the device to detect the humidity/moisture content inside the device. Several contents are susceptible to moisture and prolonged contact with high moisture content may cause degradation of the contents or may increase the rate at which the content degrades. Accordingly, measuring the humidity/moisture inside the packaging device may be helpful in determining/estimating the remaining life of the contents stored in the device. In an embodiment, the humidity sensor is configured to detect both the ambient humidity/moisture (i.e. atmospheric humidity in which the device is stored/placed) and the moisture content to which the contents of the device is exposed to (i.e. humidity or moisture content inside the packaging device). Many humidity sensors are commercially available that may be suitable for use with the device of the present disclosure.

In an embodiment, temperature sensor and/or pressure sensor and/or humidity sensor can be directly mounted to the external surface of the packaging device. Although the sensor(s) may not be in direct contact with the content stored in the device, the storage condition of the packaging device itself is in most cases a sufficient approximation of the storage condition of the content to provide reliable data. In some cases, it may be desirable to locate the sensor(s) internally within the packaging device so that the sensor is in direct contact with the content stored in the device. In some instances, it may be advantageous to place one or more sensors inside the packaging device to be in direct contact with the contents and one or more sensors directly mounted to the external surface of the packaging device.

In an embodiment, the memory is configured to store the detected at least one storage condition. Preferably, the memory is configured to store the at least one storage condition, as detected periodically or continuously by the sensor(s). In an embodiment, the memory is further configured to store the data (pertaining to storage condition as detected periodically or continuously by the sensor) integrated with the time data to aid the controller in determining the remaining shelf life of the content of the packaging device. In an embodiment, the memory is further configured to store therein, information pertaining to threshold maximum and minimum storage condition(s) appropriate for the content stored in said device. In an embodiment, the manufacturer, at the time of manufacturing (i.e. packaging the content in said device) inputs the desired storage conditions such as optimum storage temperature, humidity conditions, pressure and the likes and threshold maximum and minimum storage conditions to the memory. In an embodiment, the memory includes degradation profile(s) corresponding to different storage conditions stored therein.

In an embodiment, the controller is configured to determine, based on said detected at least one storage condition, an event of the content of the device being unfit for ingestion. In an embodiment, the controller is configured to fetch the storage condition data stored in the memory. In an embodiment, the controller fetches the storage condition details from the memory and degradation profile corresponding to the storage condition(s) to which the contents stored in the device is exposed to out of said degradation profile(s) stored in the memory. Alternatively, the controller may receive the degradation profile, corresponding to the storage condition(s) to which the contents stored in the device is exposed to, from any external source such as a computing device or a server configured to store such degradation profile(s). Once, the controller determines the degradation profile, it determines if the content is fit for the ingestion, for example, by comparing the potency of the medication stored in said packaging device or estimating the expiry date of content of the device in view of the storage conditions.

In an embodiment, the device further comprises an indicator, configured to provide any or a combination of a visual indication and an audio indication upon the detection of any or a combination of the event of the content stored in the device being expired and the event of the content of the device being unfit for ingestion. In an embodiment, the indicator comprises a display configured to provide the visual indication upon the detection of the event. In an embodiment, the indicator comprises a buzzer configured to provide the audio indication upon the detection of the event. The controller, upon detection of an event of content stored in the device being expired and/or the content being unfit for ingestion, signals the indicator to provide audio and/or visual indication towards that effect. In an embodiment, an expiration alert message may be displayed on display. In an embodiment, an expiration alter sound is raised on the device. Alternatively, such indication is sent to the computing device in communication with the packaging device. In an embodiment, the device further comprises a unique identifier associated therewith. In an embodiment, the memory is configured to store a unique identifier associated with said device.

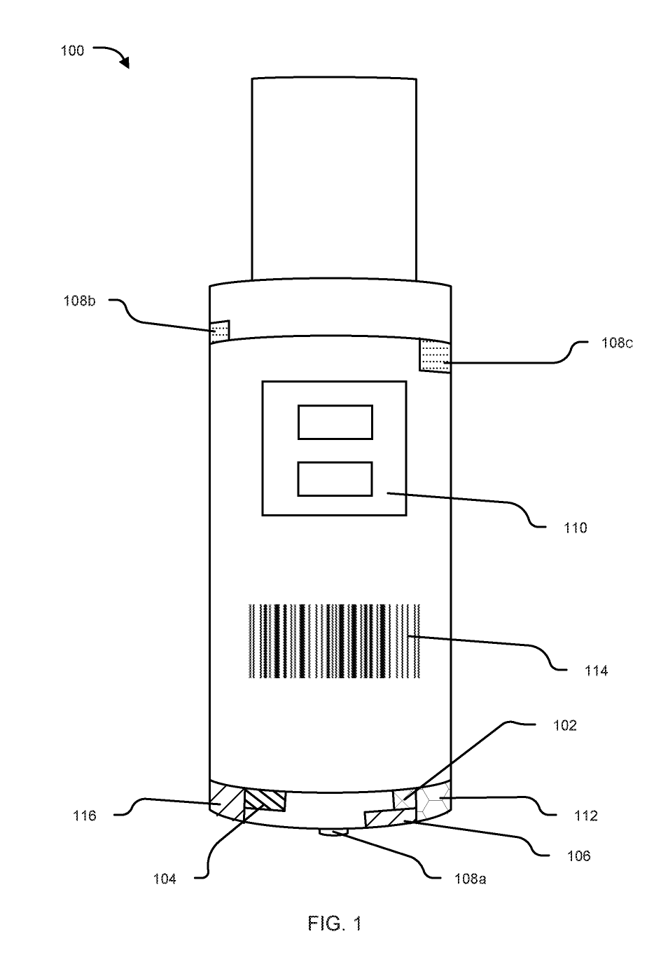

FIG. 1 illustrates an exemplary schematic depicting components of the packaging device realized in accordance with an embodiment of the present disclosure. As illustrated, the packaging device (vial) 100 includes a memory 102, a counter 104, a controller 106, one or a plurality of sensors shown as 108a, 108b and 108c, a display 110, a buzzer 112, a unique identifier 114 and a battery 116. As can also be seen from the figure, the display includes one or a plurality of LEDs (for example, one of a green color indicating the contents being fit for ingestion thereof and one of a red color indicating the contents being unfit for ingestion/expired).

Another aspect of the present disclosure relates to a method of detecting an event of a content stored in a smart packing device being expired, the method comprising the steps of: storing, in a memory associated with said device, a shelf life of the content stored in said device; determining, by a counter, a time lapsed since manufacture of said device; and detecting, by a controller, the event of the content stored in said device being expired, wherein said detection is based on determination of remaining life of the content stored in the device. In an embodiment, the determination of the remaining life is based on subtraction of the lapsed time since manufacture of said device from the shelf-life of the content stored in said device. In an embodiment, the method further comprises the step of indicating, by an indicator, the detection of the event of the content stored in said device being expired.

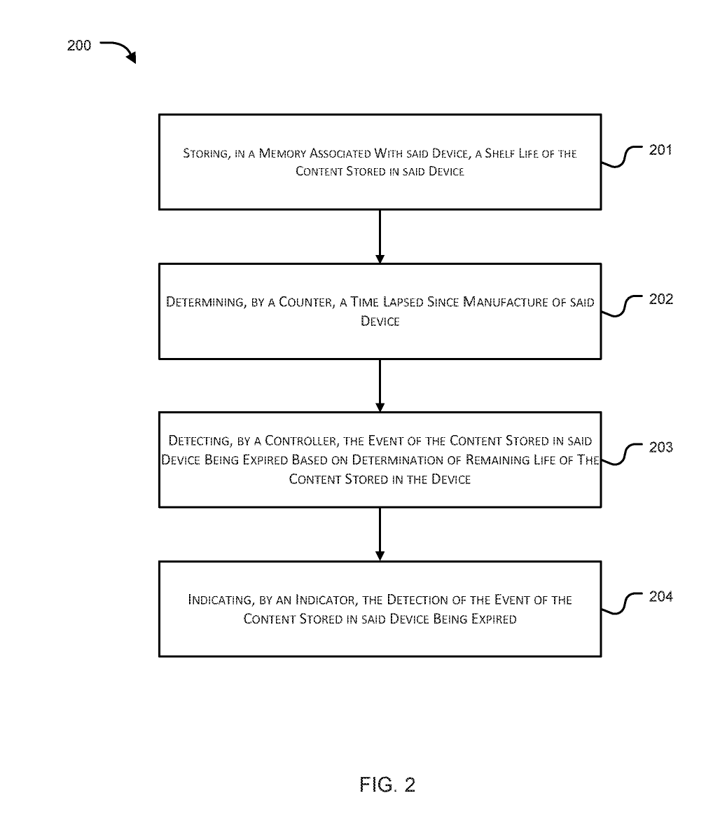

FIG. 2 illustrates an exemplary flow diagram depicting various steps involved in a method of detecting an event of a content stored in a smart packing device being expired. As illustrated, at 201, shelf life of the content stored in said device is stored in a memory associated with said packaging device, at 202, a counter determines a time lapsed since manufacture of the packaging device, at 203, a controller detects the event of the content stored in said device being expired based on determination of remaining life of the content stored in the packaging device, and at 204, an indicator provides an indication of the detection of the event of the content stored in said device being expired.

Still further aspect of the present disclosure relates to a method of detecting an event of a content stored in a smart packing device being unfit for ingestion, the method comprising the steps of: detecting at a pre-determined time period, by a sensor, at least one storage condition the content stored in said device is exposed to; storing, in a memory, the detected at least one storage condition; and determining, by a controller, the event of the content of the device being unfit for ingestion, wherein said determination is based on the detected at least one storage condition. In an embodiment, the at least one storage condition is selected from any or a combination of temperature, humidity and pressure. In an embodiment, the method further comprises the step of indicating, by an indicator, the detection of the event of the content stored in said device being unfit for ingestion.

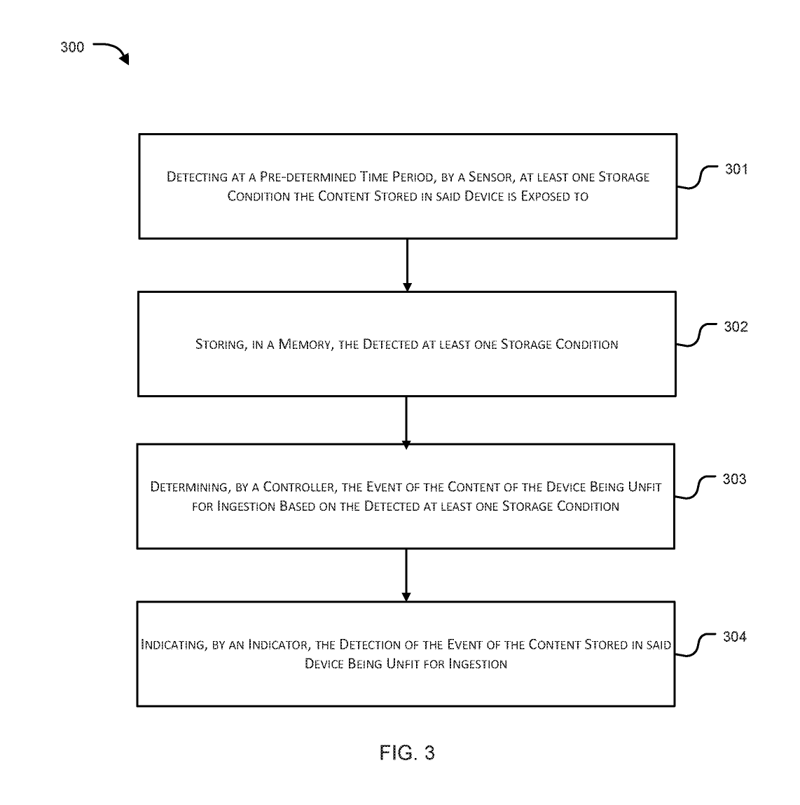

FIG. 3 illustrates an exemplary flow diagram depicting various steps involved in a method of detecting an event of a content stored in a smart packing device being unfit for ingestion. As illustrated, at 301, a sensor detects, at a pre-determined time period, at least one storage condition the content stored in said device is exposed to, at 302, detected at least one storage condition is stored in a memory, at 303 a controller determines the event of the content of the device being unfit for ingestion based on the detected at least one storage condition, and at 304, an indicator provides an indication of the detection of the event of the content stored in said device being unfit for ingestion.

Still further aspect of the present disclosure relates to an automated process for packaging of pharmaceutical/nutraceutical/cosmetic contents into a smart packaging device including a unique identifier. The process in accordance with an embodiment of the present disclosure can be divided into five sub-categories: A) Raw material processing; B) Smart packaging device production; C) Attachment of unique identification means (unique identifier) to the Smart packaging device (container); D) Container filling; and E) Final packaging.

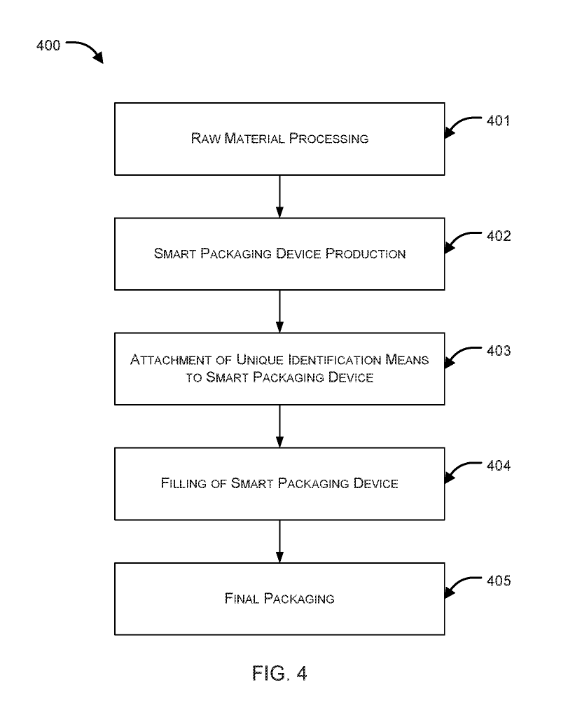

FIG. 4 enumerates different steps of a process for packaging of pharmaceutical, nutraceutical or cosmetic contents into a smart packaging device, in accordance with an embodiment of the present disclosure. In an embodiment, the pharmaceutical, nutraceutical or cosmetic contents is subjected to one or a combination of processes selected from size reduction, mixing, rolling, pre-processing to convert them into a desired shape, and the like as shown at the step 401. Parameters including one or more processing parameters and surrounding environmental factors are automatically controlled without substantial human intervention while subjecting the contents to said one or more processes. Smart packaging devices are manufactured utilizing suitable material of construction and methods as known to a person skilled in the art as shown at the step 402. The unique identification means provided with one or a combination of sensing capabilities and communication capabilities is attached to the smart packaging devices as shown at the step 403. In an embodiment, unique identification means is attached to the smart packaging device during manufacturing of the smart packaging device itself. In an alternative embodiment, manufacturing of the smart packaging device is done first and then unique identification means is attached therewith utilizing any means known to a person skilled in the art. The smart packaging device including unique identification means is then subjected to filling operation using processes known to a person skilled in the art as shown at the step 404. Various processing parameters including but not limited to amount of filling, tolerance, environmental factors and the like are sensed by the unique identification means and transmitted to a controller to control one or more of these parameters without substantial human intervention. Optionally the sensed values are stored in the memory means associated with the unique identification means. Finally, the filled smart packaging device is sealed and optionally packed into secondary packaging means as shown at the step 405. In accordance with embodiments of the present disclosure, the whole manufacturing process is automated without substantial human intervention. Further, the system and process of the present invention provides for registration of each dose through inclusion of unique identification means ensuring prevention of degradation of quality of the contents of smart packaging devices. The system and process realized in accordance with embodiments of the present disclosure allows for automated storage of packaging information and optionally processing parameters to be subsequently analysed to gain insights into the overall process quality and efficiency.

In an embodiment, the pharmaceutical, nutraceutical or cosmetic contents packed into a smart packaging device can utilize any raw material, as known to a person skilled in the art. The raw material may contain one or a combination of active ingredients or chemical entities of interest. Optionally, it may contain one or more of excipients, as known to a person skilled in the art. In an exemplary embodiment, the excipients can include wetting agents, emulsifying agents, fillers, diluents, thickening agents, solvents, coating agents, dispersing agents, preservatives, antifoaming agent and stabilizers. However, those skilled in the art will appreciate that the additional excipients can be used without departing from the scope and spirit of the present invention. In an embodiment, raw material can be of any size, shape or physical nature. In an embodiment, the raw material can be in the form of a solid, semi-solid, fibers or a liquid. In an embodiment, the raw material can be formulated into, but not limited to, tablet, capsule, syrup, suspension, powder, water dispersible granules (WG), suspension concentrates (SC), wettable powders (WP), emulsifiable concentrates (EC), granules, gel, suspo emulsions (SE), mixed formulation of capsule suspension and suspension concentrates (ZC) and the like.

In an embodiment, raw material can undergo various unit operations depending upon the product type and processing techniques. In an exemplary embodiment, the raw material can be subjected to unit operations such as grinding, cutting, milling, mixing, rolling or a combination thereof, with help of any suitable instrument, as known to a person skilled in the art. In another embodiment, raw material can be packed directly without any pre-processing. In an embodiment, during raw material processing, several parameters including surrounding environmental factors can be controlled. In an exemplary embodiment, parameters including surrounding environmental factors can be output in kg/hr, grain size, hygroscopicity of fibers, in-line packaging, temperature, pressure, light, humidity, material for packaging and the like can be controlled automatically. In an embodiment, raw material processing and packaging can be done continuously and simultaneously. In an alternate embodiment, raw material processing and packaging can be done separately. In an embodiment, the raw material after processing can be obtained in any suitable packed form, as known to a person skilled in the art. In an embodiment, the packed form of raw material is vacuum sealed.

In an embodiment, the container (smart packaging device) in which the raw material is to be filled can be made of any suitable material, as known to a person skilled in the art. In an exemplary embodiment, material of construction that can be used for the container can be selected from metal, plastic, glass, paper or combination thereof. In an embodiment, metal can be iron, copper, nickel, steel, aluminium, or combination thereof. In an embodiment, plastic can be from any source, grade, and/or type. In an embodiment, selection of container body material, quality of material, size and shape can depend on the final use of product or on the raw material that would be packed inside. In an embodiment, container can be of any shape including but not limited to tube, vial, pipe, square, sphere, box, jar, capsule, pod, bottle and the like. In a preferred embodiment, the container is a pod. In an embodiment, container can store raw material in any state of solid, liquid, gas or a combination thereof. In an embodiment, the container can store material in any amount ranging from mg to kg or ml to liter of raw material. In an embodiment, the body of the container can be made up of single piece of material. In another embodiment body of the container can be manufactured by joining multiple pieces of material by any suitable means, as known to a person skilled in the art. In an embodiment, the body of the container can be manufactured by various manufacturing processes including but not limited to, molding, extrusion, compression, trimming, casting, or a combination thereof. In certain embodiments, the body of the container can be further washed once or multiple times to remove dirt and other materials deposited on the surface during manufacturing. In other embodiments, additional coating can be done on either side of the body of the container for the protection of the body form outside or inside environment. In an embodiment, during manufacturing of container body, several parameters are controlled automatically. In an exemplary embodiment, parameters are material grade and thickness, desired output rate, method of collection, method of stacking, requirements of tooling and the like.

In an embodiment, a unique identification means are provided with any or a combination of sensing capabilities and communication capabilities and is attached to one or more pods (smart packaging device). In an embodiment, commercially available or custom made digital system can be utilized as unique identification means in the present invention. In an embodiment, shape of the digital system can be, for example, but not limited to square, oval, triangle, round, circle, rectangle and the like. In an exemplary embodiment, the digital system can be, but not limited to, barcode, NFC tags, memory chips and the like as known to a person skilled in the art. In a preferred embodiment, the unique identification means include a memory chip. Preferably, the memory chip is pre-programmed to store the data corresponding to one or more process parameters. Unique identification means of present invention works smoothly in extreme temperature and other environmental conditions. In an embodiment, the sensing function can be performed by any appropriate sensor, as known to a person skilled in the art. In an embodiment, fastening (attachment) of unique identification means on the packaging device can be done by means of any or a combination of physical means, chemical means and mechanical means. Physical means includes, but not limited to, application of magnet, heat, welding and combination thereof. Chemical means include application of a chemical including glue, adhesive, adhesive tapes and the like. Mechanical means can include utilization of screw, rivet and the like. Unique identification means can be attached to any surface of the smart packaging device. In an embodiment, unique identification means is fixed to smart packaging device before filling and sealing. In another embodiment, unique identification means is attached to the smart packaging device during manufacturing of the smart packaging device.

In an embodiment, communication between devices and/or communication between smart packaging device and controller can be one-way or two-way. In an embodiment, data from the unique identification means to a reader (or controller) can be transmitted through internet or any other suitable network, as known to a person skilled in the art. In an embodiment, several parameters are monitored by unique identification means at this stage and values and or signals corresponding to them are sent to a controller to control these parameters automatically. In an embodiment, the overall process parameters are controlled by a web based application. Alternatively, cloud based application can be utilized to control the overall process without substantial human intervention.

In an embodiment, pharmaceutical, nutraceutical or cosmetic contents can be filled in a smart container (smart packaging device) including unique identification means. In one embodiment, manual filling can be done. In a preferred embodiment, automatic or semi-automatic filling is done. In an embodiment, before filling of pharmaceutical, nutraceutical or cosmetic, container can be rinsed/degassed with N2, CO2 or combination of thereof. In an embodiment, any method of degassing/rinsing with N2 and/or CO2 can be incorporated in the present invention. In an embodiment, different analytical methods known in the prior art can be used for the quality assurance and quality control for the present invention. In an embodiment, filled container can be sealed with appropriate sealing mechanism such as, but not limited to, screw cap, capseat, wax seal cap, wax seal lid, crown cap, stopper, cork, caps, external threaded screw cap, internal threaded screw cap, or a combination thereof. In an embodiment, the sealing component can be made up of material such as metal, glass, plastic, rubber, paper or a combination thereof. In one embodiment, sealing component can be multilayer and different layers can be made up of single material. In one embodiment, sealing can be done by means of fusion of container body by heat or physical pressure. In another embodiment, seal can be tempered proof or tamper resistance. In one embodiment, sealed container can undergo one or more of quality assurance and quality control steps for the final inspection. In one embodiment, filling and sealing can be done in the cleanroom. In one embodiment, sealed container can undergo one or more processes, such as, but not limited to cleaning, washing, sterilization, labelling, or a combination thereof, in any order. In an embodiment, several parameters can be monitored by unique identification means and corresponding values and/or signals can be sent to the controller for controlling these parameters. In an exemplary embodiment, parameters are selected form rate of production, tolerance of filling, method of CO₂ and N₂ blast, method of sealing, pre-printing of Aluminum foil, and the like.

In an embodiment, the smart packaging device with unique identification means filled with the pharmaceutical, nutraceutical or cosmetic content is packed in a secondary package including but not limited to bag, blister, laminates with paper or foil, sachet, rack and box. In an embodiment, multiple containers are packed in a secondary package. Secondary packaging material can be selected from, but not limited to, cardboard, paper, glass, plastic, metal, rubber and combination thereof. Secondary packaging material can have desirable properties such as porosity, transparency, rigidity, flexibility, elasticity and the like depending on the product. In an embodiment, information such as strength, application, user guide, storage condition and other related information is printed on secondary package. Alternatively, such information can be included in the memory of the unique identification means. In an embodiment, tertiary packing can be done.

Process of the present invention can be harmonized and suited for both large scale production and small scale production with centralized overall control to substantially reducing the human intervention and hence, chances of error. The overall process, in accordance with embodiments of the present disclosure, can be done in a cleanroom with different grades to follows stipulated cGMP standards and guidelines.

I/We claim:

1. A smart packaging device to store a content therein, the device comprising:
a memory having stored therein, a shelf life of the content stored in said device;
a counter configured to determine a time lapsed since manufacture of said device; and
a controller, configured to detect an event of the content stored in said device being expired, wherein said detection is based on determination of remaining life of the content stored in the device.

2. The device as claimed in claim 1, wherein said determination of the remaining life is based on subtraction of the lapsed time since manufacture of said device from the shelf-life of the content stored in said device.

3. The device as claimed in claim 1, wherein the device further comprises a sensor, configured to detect, at a pre-determined time period, at least one storage condition the content stored in said device is exposed to.

4. The device as claimed in claim 3, wherein said at least one storage condition is selected from any or a combination of temperature, humidity and pressure.

5. The device as claimed in any of claim 3 and claim 4, wherein the memory is further configured to store the detected at least one storage condition.

6. The device as claimed in claim 5, wherein the controller is configured to determine, based on said detected at least one storage condition, an event of the content of the device being unfit for ingestion.

7. The device as claimed in claim 1, wherein the device further comprises an indicator, configured to provide any or a combination of a visual indication and an audio indication upon the detection of any or a combination of the event of the content stored in the device being expired and the event of the content of the device being unfit for ingestion.

8. The device as claimed in claim 7, wherein said indicator comprises a display configured to provide the visual indication upon the detection of the event.

9. The device as claimed in claim 7, wherein said indicator comprises a buzzer configured to provide the audio indication upon the detection of the event.

10. The device as claimed in claim 1, wherein said device further comprises a unique identifier associated therewith.

11. The device as claimed in claim 1, wherein said memory is configured to store a unique identifier associated with said device.

12. A method of detecting an event of a content stored in a smart packing device being expired, the method comprising the steps of:
storing, in a memory associated with said device, a shelf life of the content stored in said device;
determining, by a counter, a time lapsed since manufacture of said device; and
detecting, by a controller, the event of the content stored in said device being expired, wherein said detection is based on determination of remaining life of the content stored in the device.

13. The method as claimed in claim 12, wherein said determination of the remaining life is based on subtraction of the lapsed time since manufacture of said device from the shelf-life of the content stored in said device.

14. The method as claimed in claim 12, wherein the method further comprises the step of indicating, by an indicator, the detection of the event of the content stored in said device being expired.

15. A method of detecting an event of a content stored in a smart packing device being unfit for ingestion, the method comprising the steps of:
detecting at a pre-determined time period, by a sensor, at least one storage condition the content stored in said device is exposed to;
storing, in a memory, the detected at least one storage condition; and
determining, by a controller, the event of the content of the device being unfit for ingestion, wherein said determination is based on the detected at least one storage condition.

16. The method as claimed in claim 15, wherein said at least one storage condition is selected from any or a combination of temperature, humidity and pressure.

17. The method as claimed in claim 15, wherein the method further comprises the step of indicating, by an indicator, the detection of the event of the content stored in said device being expired.
